(19) United States
(12) Patent Application Publication
(10) Pub. No.: US 2012/0061070 A1
(43) Pub. Date: Mar. 15, 2012

(54) THERMAL CONTROL SYSTEM FOR AN ELECTRONIC DEVICE

(76) Inventors: Alexander Kornitz, Coquitlam (CA); Mirak Pospisil, West Vancouver (CA)

(21) Appl. No.: 13/281,346

(22) Filed: Oct. 25, 2011

Related U.S. Application Data
(63) Continuation-in-part of application No. 12/182,972, filed on Jul. 30, 2008, now Pat. No. 8,070,324.

(51) Int. Cl. G05D 23/00

(52) U.S. Cl. 165/287

(57) ABSTRACT

A thermal control system for an electronic device comprises a negative temperature coefficient thermistor array thermally coupled to a heat sink. The negative temperature coefficient thermistor array may be disposed within a thermal conductive member. A power supply is electrically connected to the negative temperature coefficient thermistor array. A cooling device is electrically connected in series with the power supply and the negative temperature coefficient thermistor array. The negative temperature coefficient thermistor array is between the power supply and the cooling device. A rheostat may further be electrically connected, in series, between the negative temperature coefficient thermistor array and the power supply

### CROSS-REFERENCE TO RELATED APPLICATION

This application is a continuation-in-part of application Ser. No 12/182,972 filed in the United States Patent and Trademark Office on Jul. 30, 2008, and to which priority is claimed.

### BACKGROUND OF THE INVENTION

1. Field of the Invention

The present invention relates to a thermal control system for an electronic device and, in particular, to a thermal control system comprising a the negative temperature coefficient thermistor array.

2. Description of the Related Art

Light-emitting diodes, like any semiconductor, emit heat during their operation. This is because not all of the electrical energy provided to a light-emitting diode is converted to luminous energy. A significant portion of the electrical energy is converted to thermal energy which results in an increase in the temperature of the light-emitting diode. In resistor driven circuits, as the temperature of the light-emitting diode increases, the forward voltage drops and the current passing through the PN junction of the light-emitting diode increases. The increased current causes additional heating of the PN junction and may thermally stress the light-emitting diode.

Thermally stressed light-emitting diodes lose efficiency and their output is diminished. In certain situations, optical wavelengths may even shift causing white light to appear with a blue tinge. Thermally stressed light-emitting diodes may also impose an increased load on related driver components causing their temperature to increase as well. This may result in broken wire bonds, delaminating, internal solder joint detachment, damage to die-bond epoxy, and lens yellowing. If nothing is done to control the increasing temperature of the light emitting diode, the PN junction may fail, possibly resulting in thermal runaway and catastrophic failure.

Thermal control of light-emitting diodes involves the transfer of thermal energy from the light-emitting diode. Accordingly, one aspect of light-emitting diode fixture design involves efficiently transferring as much thermal energy as possible away from the PN junction of the light-emitting diode. This can generally be accomplished, at least in part, through the use of a heat sink. However, for more powerful light-emitting diode fixtures in the 20 to 60 watt range or in applications where numerous light-emitting diodes are disposed within a confined space, an additional cooling means may be required to maintain performance. This is because the thermal energy generated by the light-emitting diodes may at times exceed the thermal energy absorbed and dissipated by the heat sink. In these situations a cooling fan is typically used in combination with the heat sink.

In a conventional thermal control system for light-emitting diode fixtures, a heat sink and a cooling fan are thermally coupled to a light source comprised of a plurality of light-emitting diodes. A thermal sensor senses the temperature of the light source and signals a controller to operate a variable speed cooling fan, based on the temperature of the light source, to maintain the fixture within a desired temperature range. However, the need for a controller, typically in the form of microprocessor, increases the number of components in the thermal control system and thereby increases manufacturing costs.

### BRIEF SUMMARY OF THE INVENTION

It is an object of the present invention to provide an improved thermal control system for an electronic device.

In particular, it is an object of the present invention to provide a thermal control system for an electronic device which has a reduced number of component parts.

Accordingly, there is provided a thermal control system for an electronic device comprising a negative temperature coefficient thermistor array thermally coupled to a heat sink. The negative temperature coefficient thermistor array may be disposed within a thermally conductive member. A power supply is electrically connected to the negative temperature coefficient thermistor array. A cooling device is electrically connected in series with the power supply and the negative temperature coefficient thermistor array. The negative temperature coefficient thermistor array is between the power supply and the cooling device A rheostat may further be electrically connected, in series, between the negative temperature coefficient thermistor array and the power supply.

There is also provided an electronic device having a thermal control system. The electronic device comprises a heat sink. A negative temperature coefficient thermistor array is thermally coupled to the heat sink. The negative temperature coefficient thermistor array may be disposed within a thermally conductive member. A power supply is electrically connected in parallel to the light-emitting diode and the negative temperature coefficient thermistor array. A cooling device is electrically connected in series with the power supply and the negative temperature coefficient thermistor array. The negative temperature coefficient thermistor array is between the power supply and the cooling device. A rheostat may further be electrically connected, in series, between the negative temperature coefficient thermistor array and the power supply.

### BRIEF DESCRIPTION OF THE DRAWINGS

The present invention will be more readily understood from the following description of preferred embodiment thereof given, by way of example, with reference to the accompanying drawings, in which:

FIG. 1 is a simplified block diagram of an improved thermal control system for an electronic device in the form of a light-emitting diode fixture according to an embodiment of the present invention;

FIG. 2 is a circuit diagram of the thermal control system of FIG. 1;

FIG. 3 is a perspective view, partly in section, of a light-emitting diode fixture provided with the thermal control system of FIG. 1; and

FIG. 4 is a graph showing various temperatures of a light-emitting diode fixture provided with the thermal control system of FIG. 1.

### DESCRIPTION OF THE PREFERRED EMBODIMENTS

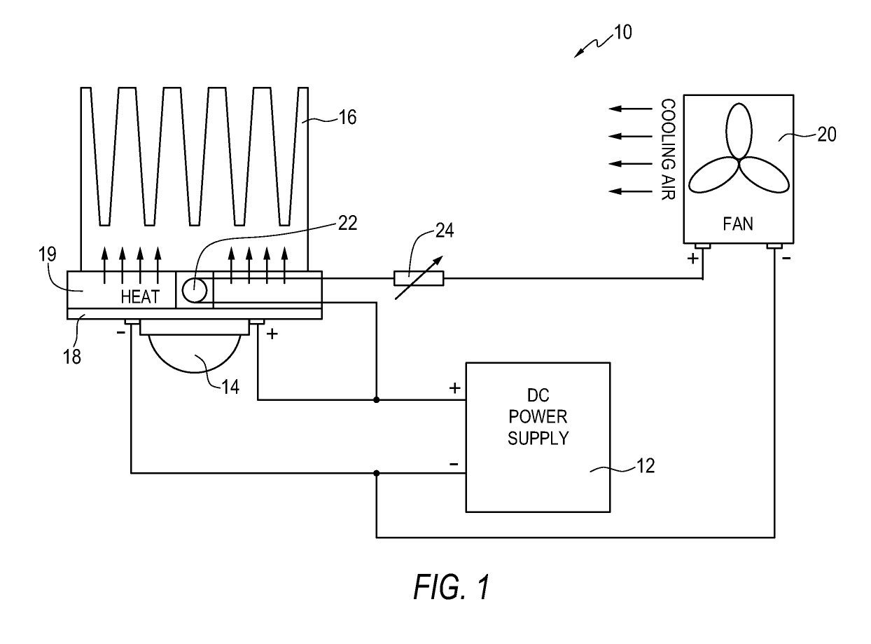

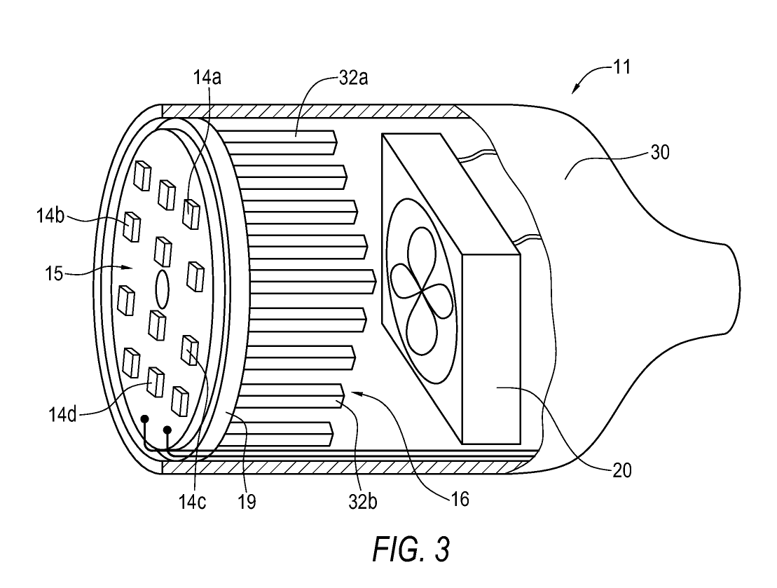

Referring first to FIG. 1, this shows a simplified block diagram of an improved thermal control system cooling system 10 for an electronic device which, in this is example, is light-emitting diode fixture 11 shown in FIG. 3. Referring back to FIG. 1, a DC power supply 12 is connected to a light-emitting diode 14 mounted on a printed circuit board 18. In this example, the light-emitting diode 14 and printed circuit board 18 are thermally coupled to heat sink 16 by a thermal conductive member, in this example, a metal plate 19. However, this is not a requirement. The metal plate 19, preferably formed of copper or aluminum, is disposed between the printed circuit board 18 and the heat sink 16. The power supply 12 is also connected to a cooling device which, in this example, is cooling fan 20. A thermistor 22, thermally coupled to the heat sink 16, is connected in series between the DC power supply 12 and the cooling fan 20. Preferably the thermistor 22 is disposed within, or nested in, the metal plate 19. A resistor, in the form of a rheostat 24, is further connected in series between the thermistor 22 and the cooling fan 20. The cooling fan 20, thermistor 22, and rheostat 24 define a control circuit.

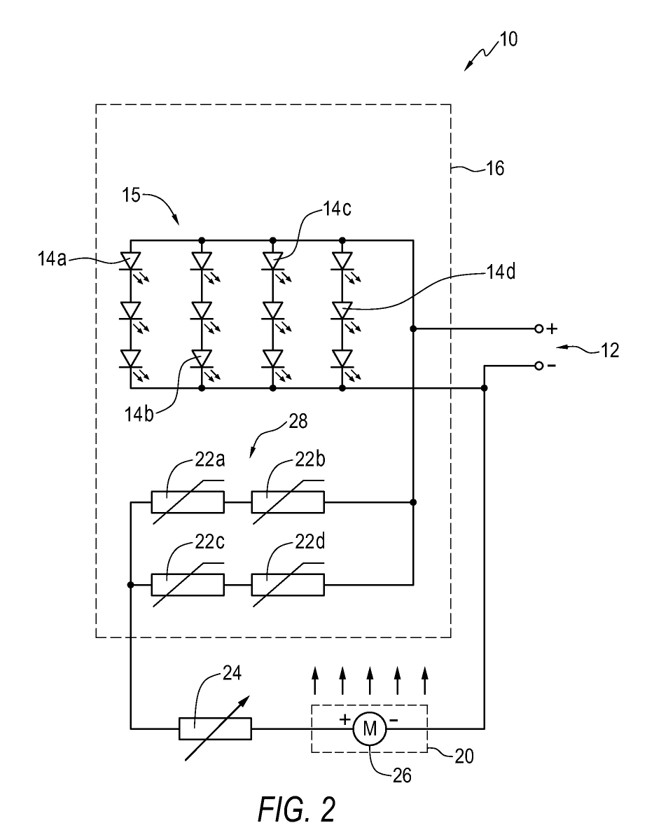

Referring now to FIG. 2, this shows a circuit diagram of the thermal control system 10. A plurality of light-emitting diodes 14a, 14b, 14c, and 14d form an LED array 15. As shown in FIG. 2, the light-emitting diodes may be connected in both series and in parallel. The LED array 15 is thermally coupled to the heat sink 16 and the DC power supply 12 provides current to the individual light-emitting diodes 14a, 14b, 14c, and 14d. The LED array 15 converts electrical energy from the current provided by the DC power supply 12 into both luminous energy and thermal energy. The luminous energy is emitted as light and the thermal energy is absorbed and subsequently dissipated by the heat sink 16.

The DC power supply 12 also provides current to a DC motor 26 of the cooling fan 20. A plurality of negative temperature coefficient thermistors 22a, 22b, 22c, and 22d, connected in both series and in parallel, form a thermistor array 28 which itself is connected in series between the DC power supply 12 and the cooling fan 20. The thermistor array 28 is thermally coupled to the heat sink 16 and is sensitive to the temperature of the heat sink 16. As the temperature of the heat sink 16 increases, the resistance of the thermistor array 28 decreases. As the temperature of the heat sink 16 decreases, the resistance of the thermistor array 28 increases. Accordingly, the flow of current to the motor 26 of the cooling fan 20 is a function of the temperature of the heat sink 16.

The rheostat 24, which is connected in series between the thermistor array 28 and the cooling fan 20, controls the speed of the motor 26 of the cooling fan 20 in a manner well known in the art and accordingly not described in detail herein. This is desirable to further conserve energy and minimize noise however it is not required. Other embodiments of the thermal control system may not include a rheostat connected in series between the thermistor array and the cooling fan. In such embodiments the cooling fan simply operates in an operational/non-operational manner dependent on the flow of current to the motor of the cooling fan which, as a result of the thermistor array, is a function of the temperature of the heat sink. Furthermore, it will be understood by a person skilled in the art that in other embodiments of the thermal control system other wiring diagrams for the light-emitting diodes and thermistors may be used to form the LED array and the thermistor array.

Referring now to FIG. 3, this shows the thermal control system 10 disposed within a housing 30 of the light-emitting diode fixture 11. Preferably, the heat sink 16 is connected to the housing 30 and a rear of the housing 30 incorporates the heat sink 16. This structure has been shown to be especially successful at dissipating thermal energy. The heat sink 16 is formed of copper or aluminum in this example and has a plurality of fins 32a and 32b which increase the surface area of the heat sink 16. Thermal energy generated by the light-emitting diodes 14a, 14b, 14c, and 14d in the LED array 15 is transferred to the heat sink 16 by conduction. The cooling fan 20 is also disposed within the housing 30 and faces the heat sink 16. The cooling fan 20 provides cooling air to the heat sink 16 to assist in transfer of thermal energy from heat sink 16 by convection. The addition of the cooling air increases the efficiency of the heat sink 16 by 20%-30%.

To select the appropriate component values for the thermal control system 10, the following algorithm is used:
1. The approximate total power consumption (Ps) of the LED array is determined using the following equation.

P_{S}=P_{D}×N (Equation 1)

where
P_{D} is the nominal value power of the individual light-emitting diodes; and
N is the total number of light-emitting diodes in the LED array.
2. Based on the wiring diagram of the LED array the required voltage (V_{S}) is determined using the following equation:

V_{S}=V_{f}×n (Equation 2)

where
V_{f} is the forward voltage drop of the light-emitting diodes; and
n is the number of light-emitting diodes which are connected in series in the LED array.
   and the required current (I_{S}) is determined using the following equation:

I_{S}=I_{f}×m (Equation 3)

where
I_{f} is the forward current of the light-emitting diodes; and
m is the number of strings or legs connected in parallel in the LED array.
3. Based on the total power consumption (P_{S}) of the LED array the approximate value of the necessary dissipative surface area (S_{HS}) of the heat sink to achieve a desired temperature (T_{PCB}) of the LED array is determined using the following equation:

S_{HS}=P_{S}/S_{I} (Equation 4)

where
S_{I} is the value of the minimum dissipative surface area of the heat sink required to maintain the desired temperature (T_{PCB}) of the LED array and to compensate for thermal energy from 1 W of the total power consumption (P_{S}) of the LED array. The S_{I} values can be obtained by statistical analysis of experimental data from trials on different heat sinks and LED arrays.
4. Based on the necessary dissipative surface area (S_{HS}) of the heat sink and aesthetic design considerations, the base area (S_{B}), or footprint, of the heat sink and the height (H_{HS}) of the heat sink are determined using known geometric principles.
5. Based on the power consumption (P_{S}) of the LED array, the required voltage (V_{S}), the required current (I_{S}), the base area (S_{B}) of the heat sink, and the height (H_{HS}) of the heat sink the type, quantity, and connection diagram for the cooling fan or fans used in the thermal control system is determined to satisfy the following conditions:

The total power (P_{FT}) applied to the fans must not be more than:

P_{FT}≦(0.05 to 0.1)×P_{S} (Equation 5)

The voltage drop (V_{FS}) of the fan or series-connected fans and the voltage drop of the control circuit (V_{C}), ie forward voltage drop of the series connection of the resistance of the thermistor array and the rheostat, must not be more than:

V_{FS}+V_{C}=V_{S} (Equation 6)
Taking into account that:

P_{S}=V_{S}×I_{S} (Equation 7)
and considering Equation 5 and Equation 6, the value of current (I_{FS}) through the fan or series-connected fans and the control circuit:

I_{FS}=I_{C}=(0.05 to 0.1)×I_{S} (Equation 8)
Empirical analysis has shown that an acceptable proportion between V_{FS} and V_{C} can be defined as:

V_{FS}=0.6×V_{S} (Equation 9)
accordingly

V_{C}=0.4×V_{S} (Equation 10)

On the basis of Equation 5, Equation 8, and Equation 9 the appropriate type of fans can be selected. The overall dimensions of the selected fans must be matched with the calculated overall dimensions of the heat sink.
6. An acceptable proportion between the voltage drop (V_{T}) of the thermistor and the voltage drop (V_{R}) in the control circuit has been determined from empirical analysis and is defined as follows:

V_{T}=(0.7×V_{C})=(0.7×(0.4×V_{S}))=(0.28×V_{S})≈(0.3×V_{S}) (Equation 11)

V_{R}=(0.3×V_{C})=(0.3×(0.4×V_{S}))=(0.12×V_{S})≈(0.1×V_{S}) (Equation 12)
7. The equivalent resistance of the LED array is:

R_{S}=V_{S}/I_{S} (Equation 13)
8. Based on Equation 8, Equation 11, and Equation 13 the value (R_{T}) of the thermistor is determined using the following equation:

R_{T}=(V_{T}/I_{C})=(0.3×V_{S})/(0.05 to 0.1)I_{S}≈(3 to 6)R_{S} (Equation 14)
9. Based on Equation 8 and Equation 11 the value of (P_{T}) the power dissipated by the thermistor is determined using the following equation:

P_{T}=(V_{T}×I_{C})=(0.3×V_{S})×(0.05 to 0.1)I_{S}≈(0.015 to 0.03)P_{S} (Equation 15)
which is equal to just 1.5% to 3.0% of the power dissipated by the LED array.
10. Based on Equation 8, Equation 12 and Equation 13 the value R_{R} is determined using the following equation:

R_{R}=(V_{R}/I_{C})=(0.1×V_{S})/(0.05 to 0.1)I_{S}≈(1 to 2)R_{S} (Equation 16)
11. Based on Equation 8 and Equation 12 the value of (P_{R}) the power dissipated by the rheostat is determined using the following equation:

P_{R}=(V_{R}×I_{C})=(0.1×V_{S})×(0.05 to 0.1)I_{S}≈(0.005 to 0.01)P_{S} (Equation 17)
which is equal to just 0.5% to 1.0% of the power dissipated by the LED array.
12. Considering Equation 8 and Equation 9 together with the fact that current through the control circuit also flows through the fan it follows:

R_{FS}=(V_{F}/I_{C})=(0.6×V_{S})/(0.05 to 0.1)I_{S}≈(6 to 12)R_{S} (Equation 18)

It will be understood by a person skilled in the art that Equation 14, Equation 15, Equation 16, and Equation 18 provide the ability to select the basic components of the thermal control system 10, i.e. the thermistors 22a, 22b, 22c, and 22d, the rheostat 24, and the cooling fan 20 using one basic value, namely, the resistance (R_{S}) of the LED array 15.

Based on the resistance (R_{T}) of the thermistor array 28 calculated using Equation 14, the current (I_{C}) flowing through the cooling fan 20 calculated using Equation 8, and the base area (S_{B}) or footprint of the heat sink 16, a person skilled in the art can readily determine the number of thermistors required in the thermistor array 28 as well as the required electrical connection between the thermistors, whether in series, in parallel, or both, to satisfy the conditions of Equation 14. On this basis nesting of the thermistors 22a, 22b, 22c, and 22d, into the base of the heat sink 16 and the general line-up of the thermal control system 10 can be determined.

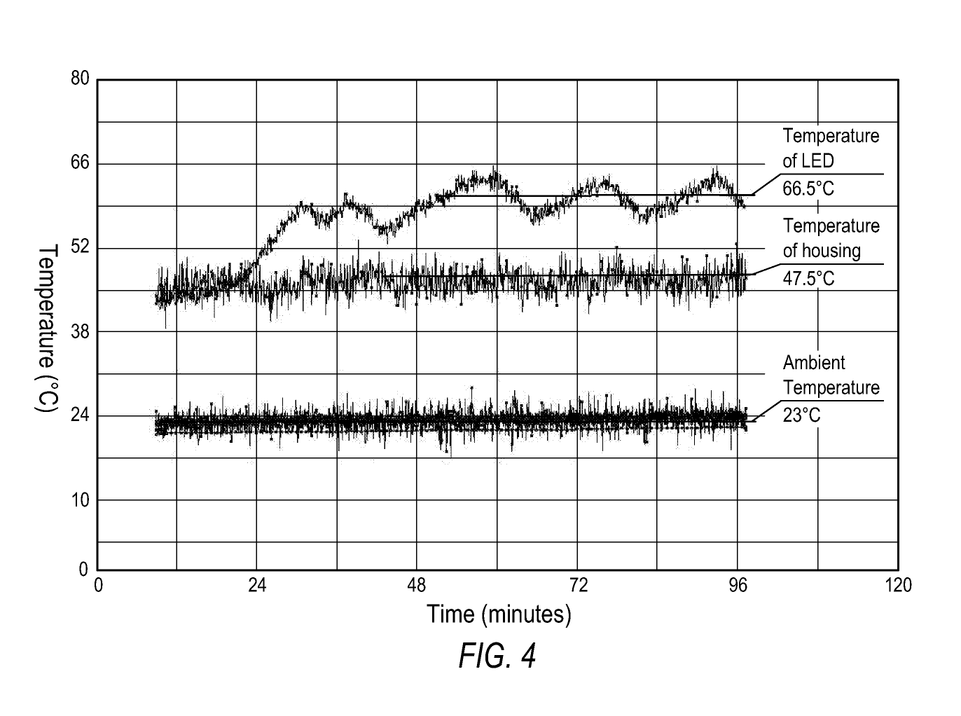

In operation, the temperature of the fixture 11 varies due to changing ambient temperatures and electrical loads. When the fixture 11 is ON, the temperature of the fixture 11 exceeds the temperature of the ambient environment, or room temperature, as best shown in FIG. 4. This is because electrical energy supplied to the light-emitting diodes 14a, 14b, 14c, and 14d by the DC power supply 12, is converted to both luminous and thermal energy. The thermal energy is, in part, absorbed and dissipated by the heat sink 16 allowing the light-emitting diodes 14a, 14b, 14c, and 14d to remain near a predetermined set temperature point to prevent thermal runaway.

As the temperature of the heat sink 16 increases and when it exceeds a threshold temperature point, the resistance of the thermistor array 28 decreases. This causes an increased current flow from the DC power source 12, through the thermistor array 28 and the rheostat 24, to the cooling fan 20. The increased current flow to the cooling fan 20 results in an increase in the output of the cooling fan 20. The cooling fan 20 blows cooling air over and/or through the heat sink 16 to increase the heat transfer coefficient, i.e. the rate at which the heat sink 16 transfers the thermal energy to the ambient environment, thereby increasing the efficiency of the heat sink 16 and preventing the fixture 11 from overheating.

As the temperature of the heat sink 16 decreases in response to the cooling air provided by the fan, the resistance of the thermistor array increases. This causes a decrease in the current flow from the DC power source 12, through the thermistor array 28 and the rheostat 24, to the cooling fan 20. The decreased current flow to the cooling fan 20 results in a decrease in the output of the cooling fan 20 thereby conserving energy and minimizing noise. When the temperature of the heat sink 16 falls below the threshold temperature the cooling fan 20 in non-operational. Accordingly, in conditions where the heat sink 16 alone is able to effectively dissipate the thermal energy generated by the light-emitting diodes 14a, 14b, 14c, and 14d the cooling fan 20 is non-operational. When the temperature of the heat sink again increases and exceeds the threshold value the cooling fan 20 is again operational.

As shown in FIG. 4, by operating in a cyclic operational/non-operational manner, as described above, the cooling fan 20 is able to maintain the heat sink 16, and by extension the LED array 15, within a desired temperature range when the fixture 11 is ON. It will be understood that when the fan is operational it may operate consistently at full speed or at variable speeds dependent on the circuitry of the thermal control system 10.

It will be understood by a person skilled in the art that although, in the example described herein, the electronic device is a light-emitting diode fixture that the thermal control system disclosed herein may be used with any suitable electronic device.

It will be understood by someone skilled in the art that many of the details provided above are by way of example only and are not intended to limit the scope of the invention which is to be determined with reference to the following claims.

What is claimed is:

1. A thermal control system for an electronic device comprising:
a heat sink;
a negative temperature coefficient thermistor array thermally coupled to the heat sink;
a power supply electrically connected to the thermistor array; and
a cooling device electrically connected in series with the power supply and the thermistor array, wherein current used to power the cooling device flows from the power supply and through the thermistor array to the cooling device, and the thermistor array controls said current flow from the power supply to the cooling device based on a temperature of the heat sink which is thermally coupled to the thermistor array, thereby controlling the output of the cooling device based on the temperature of the heat sink.

2. The thermal control system as claimed in claim 1 further including a rheostat electrically connected in series between the thermistor array and the power supply.

3. The thermal control system as claimed in claim 1 wherein the heat sink is integral with a housing of the electronic device.

4. The thermal control system as claimed in claim 1 wherein the negative temperature coefficient thermistor array is connected in series.

5. The thermal control system as claimed in claim 1 wherein the negative temperature coefficient thermistor array is connected in parallel.

6. The thermal control system as claimed in claim 1 wherein the negative temperature coefficient thermistor array is disposed within a thermally conductive member.
